(19) United States
(12) Patent Application Publication
(10) Pub. No.: US 2022/0015162 A1
(43) Pub. Date: Jan. 13, 2022

(54) DATA TRANSMISSION FROM A MACHINE DEVICE TO A NETWORK NODE

(71) Applicant: Telefonaktiebolaget LM Ericsson (publ), Stockholm (SE)

(72) Inventors: Gonzalo CAMARILLO GONZALEZ, HELSINKI (FI); Ari KERÄNEN, HELSINKI (FI)

(21) Appl. No.: 17/297,650

(22) PCT Filed: Nov. 28, 2018
(86) PCT No.: PCT/SE2018/051227

§ 371 Date: May 27, 2021

(51) Int. Cl. H04W 76/11; H04W 4/70; H04W 4/38

(52) U.S. Cl. CPC H04W 76/11; H04W 84/18; H04W 4/38; H04W 4/70

(57) ABSTRACT

Embodiments described herein relate to methods and apparatus for transmitting data from a machine device to a network node. A method in a machine device comprises populating a name field in data to be transmitted to the network node with a first pointer value associated with a first name for the machine device, and transmitting the data to the network node, wherein the first name comprises an identification of the machine device established on connection of the machine device to the network node.

### TECHNICAL FIELD

Embodiments described herein relate to methods and apparatus for transmitting data from a machine device such as a sensor or actuator to a server. In particular, a base name field in the data is populated with a first pointer value associated with a first base name for the machine device.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly, as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Machine devices such as sensors or actuators, for example, in Internet of Things (IoT) deployments, typically report their measurements using a standard format for interoperability. SenML (see, for example, https://tools.ietf.org/html/rfc8428) is a widely-used such format, used by for example Open Mobile Alliance (OMA) Lightweight Machine to Machine (LwM2M) communication and Internet Protocol for Smart Objects.

A machine device may be configured to encode data to be transmitted to a server (in some cases via a gateway) for example, one or more measurements, using SenML. The SenML data may be transported using a protocol such as Hypertext Transfer Protocol (HTTP) or Constrained Application Protocol CoAP.

It is expected that a large number of IoT sensors may be connected to the network using low-bandwidth radio networks such as LPWA (Low Power Wide Area) networks. Narrowband (NB)-IoT is an example of an LPWA technology.

When sending IP-based IoT traffic over LPWA networks it is common to use compression techniques such as Robust Header Compression (RoHC) [2] or Static Context Header Compression (SCHC) [3].

LPWA technologies, such as NB-IoT, provide a relatively low amount of bandwidth. At the same time, IP-based IoT protocols are often not fully optimized for the most low-bandwidth links. Sending data using LPWA technologies may therefore be wasteful in terms of the amount of traffic transmitted and the energy spent transmitting the traffic. Transmission delays can also become excessively high.

RoHC and SCHC compression schemes only compress the protocols carrying SenML data (e.g., IPv6, UDP, and CoAP) and not the SenML data itself. Nevertheless, a SenML document can be quite large. Also RoHC and SCHC only apply on the single link where they are available and usually cannot be used in end-to-end compression.

Generic signaling compression mechanisms, such as signaling compression (SigComp), are not suitable for IoT deployments. Constrained machine devices (e.g., sensors) are usually not able to build up dynamic compression dictionaries across message exchanges. Generic static dictionaries, such as the one used for Session Initiation Protocol (SIP) and Session Description Protocol (SDP), cannot be used to compress unique identifiers such as SenML base names either, as the number of potential identifiers may be too large to include in a generic static dictionary.

### SUMMARY

According to embodiments described herein there is provided a method in a machine device for transmitting data to a network node. The method comprises populating a name field in data to be transmitted to the network node with a first pointer value associated with a first name for the machine device, and transmitting the data to the network node, wherein the first name comprises an identification of the machine device established on connection of the machine device to the network node.

According to some embodiments there is provided a machine device for transmitting data to a server. The machine device comprises processing circuitry configured to: populate a name field in data to be transmitted to the network node with a first pointer value associated with a first name for the machine device, and transmit the data to the network node, wherein the first name comprises an identification of the machine device established on connection of the machine device to the network node.

According to some embodiments there is provided a method, in a network node, for receiving data from a machine device. The method comprises receiving data from the machine device, and determining a first name of the machine device based on a pointer value in a name field of the data, wherein the first name comprises an identification of the machine device established on connection of the machine device to the network node.

According to some embodiments there is provided a network node, for receiving data from a machine device. The network node comprises processing circuitry configured to: receive data from the machine device, and determine a first name of the machine device based on a pointer value in a name field of the data, wherein the first name comprises an identification of the machine device established on connection of the machine device to the network node.

According to some embodiments there is provided a method in a registry node for storing pointer values for use in compressing data transmitted from a machine device to a network node. The method comprises receiving an indication from the machine device that a first pointer value is associated with a first information type of a first name of the machine device, storing the first pointer value associated with the first information type, and responsive to receiving an indication of the first pointer value from the network node, transmitting the first information type to the network node.

According to some embodiments there is provided a registry node for storing pointer values for use in compressing data transmitted from a machine device to a network node. The registry node comprises processing circuitry configured to: receive an indication from the machine device that a first pointer value is associated with a first information type of a first name of the machine device, store the first pointer value associated with the first information type, and responsive to receiving an indication of the first pointer value from the network node, transmit the first information type to the network node.

### BRIEF DESCRIPTION OF THE DRAWINGS

For a better understanding of the present invention, and to show how it may be put into effect, reference will now be made, by way of example only, to the accompanying drawings, in which:—

FIG. 1 illustrates a plurality of machine devices in communication with a network node according to some embodiments;

FIG. 2 illustrates a method in a machine device according to some embodiments;

FIG. 3 illustrates a method in a network node according to some embodiments;

FIG. 4 illustrates a method in a registry node according to some embodiments;

FIG. 5 illustrates a network node according to some embodiments;

FIG. 6 illustrates a machine device according to some embodiments;

FIG. 7 illustrates a registry node according to some embodiments.

### DESCRIPTION

The following sets forth specific details, such as particular embodiments for purposes of explanation and not limitation. But it will be appreciated by one skilled in the art that other embodiments may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers that are specially adapted to carry out the processing disclosed herein, based on the execution of such programs. Nodes that communicate using the air interface also have suitable radio communications circuitry. Moreover, the technology may additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors, one or more processing modules or one or more controllers, and the terms computer, processor, processing module and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In order to reduce the amount of traffic transmitted by machine devices, such as sensor devices (e.g. a temperature sensor or vibration sensor) or actuator devices (e.g., a door lock or controllable valve), a new data field may be introduced in the data that may replace, for example, the contents of SenML base names, with a pointer value. The pointer value indicates a piece of data that is known to both the machine device, and the network node receiving the transmitted data (e.g., a gateway or the IoT server). For example, a pointer value can point to an identification of the machine device, for example, the machine device's IPv6 address or to the public key of the machine device.

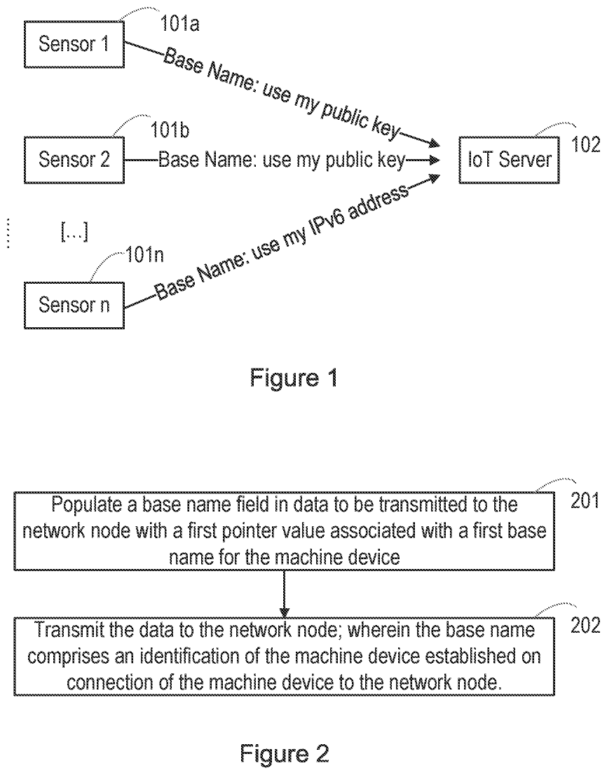

FIG. 1 illustrates a plurality of machine devices 101a to 101n, which in this example comprise sensor devices, in communication with network node 102, which in this example comprises an Internet of Things (IoT) server 102.

Each of the machine devices 101a is transmitting data to the network node 102. As the machine devices may be constrained in bandwidth, the amount of data transmitted is of importance. To reduce the size of the data transmitted, the identification, for example the base name in SenML, of the machine device in the data may be replaced by a pointer value. The name field identifying the machine device in data formats such as SenML, may consist of a fairly long identifier, which usually is a substantial part of the data transmission in terms of bandwidth.

FIG. 2 illustrates a method, in a machine device, for transmitting data to a network node. In this example, the machine device may comprise, for example, a sensor device or an actuator device. The network node may comprise a network gateway connected to transmit the data to a server, or the network node may comprise the server itself. For example, the machine device may comprise any one of the sensor device 101a to 101n illustrated in FIG. 1.

In step 201, the machine device populates a name field in the data to be transmitted to the network node with a first pointer value associated with a first name for the machine device.

In step 202, the machine device transmits the data to the network node, wherein the first name comprises an identification of the machine device established on connection of the machine device to the network node. In other words, upon connection of the machine device to the network server, or during a connection process, the machine device may exchange information with the network node, including some identification, or first name, of the machine device itself. At this stage the identification of the machine device may be transmitted to the network node in full.

For example, the first name may comprise certificate or encryption information that may be obtained by the network node, for example, from the Transport Layer Security (TLS) handshake if CoAP, HTTP or Message Queuing Telemetry Transport (MQTT) over TLS is used. In some examples, the first name comprises an Internet Protocol (IP) address, and IP address information may always be available to both the network node and the machine device when IP technologies are used. In some examples, the IP address may change due to Network Address Translations (NATs), and the network node may therefore track these changes if consistency over time is desired. For non-IP technologies other node-specific identifiers can be used (e.g., Long Range End-Device Identifier (LoRa DevEUI)). In some examples, for machine devices that form part of another containing device, any of the identifiers discussed above from the containing device, combined with a device specific identifier for the machine device unique within the scope of the containing device (e.g., a sequence number), may be used as the first name. In some examples, for a machine device whose physical location is known, a string presentation of the location (e.g., “room5241-ceiling”) may be used as the first name.

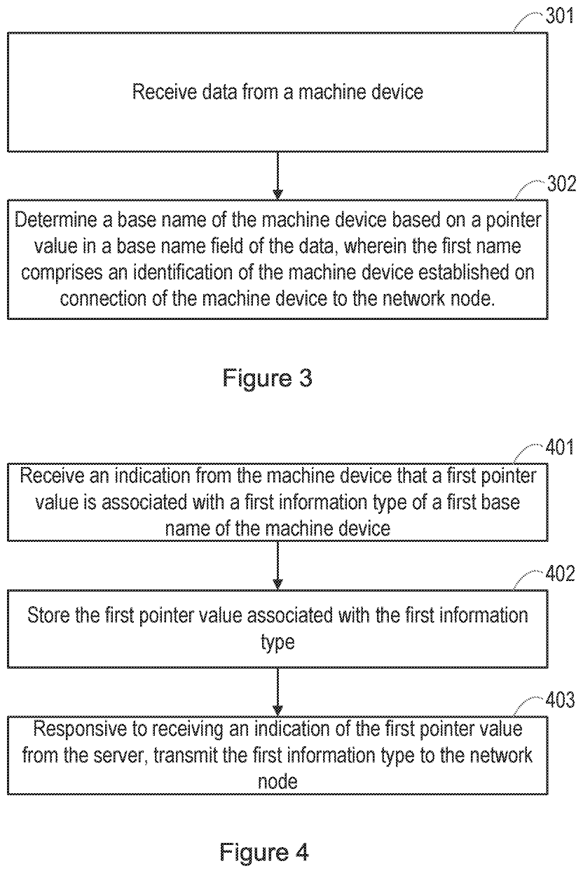

FIG. 3 illustrates a method, in a network node, for receiving data from a machine device. As previously, the machine device may comprise, for example, a sensor device or an actuator device. The network node may comprise a network gateway connected to transmit the data to a server, or the network node may comprise the server itself. For example, the network node may comprise the server 102 illustrated in FIG. 1.

In step 301, the network node receives data from the machine device.

In step 302, the network node determines a first name of the machine device based on a pointer value in a name field of the data, wherein the first name comprises an identification of the machine device established on connection of the machine device to the network node.

For example, the machine device may be configured to transmit data to the network node using a Sensor Measurement Lists (SenML) format. SenML transmissions may comprise the following fields:
Base Name=“bn”
Base Time=“bt”
Base Unit=“bu”
Base Value=bv”
Base Sum=“bs”
Base Version=“bver”
Name=“n”
Unit=u
Value=“v”
String Value=“vs”
Boolean Value=“vb”
Data Value=“vd”
Sum=“s”
Time=“t”
Update Time=“ut”

The “bn” field (together with the “n” field when present, or alternatively a field specific for the use of the pointer value, which may be named “bp”) may comprise information uniquely identifying the machine device, for example, a first name. Previously, the machine device may have transmitted a full identification of the machine device, or the full first name, each time the “bn” field (or “n” field) was required. In this example therefore a name field to be populated by a pointer value as in step 201 of FIG. 2, may comprise the field “bn”, the field “n” or a field “bp” which may be a name field specific for the use of a pointer value.

For example, the first name of the machine device, uniquely identifying the machine device, may comprise one of: an encryption certificate for the machine device, an IP address of the machine device, or a fingerprint of an encryption certificate for the machine device.

However, in examples described herein, a set of pointer values may be agreed upon by the machine device and the network node or a registry node. For example, the pointer values may be standardized between the network node and the machine node, or registered at a registry node. For example, the pointer value “p:1” may refer to the machine device's public key and the pointer value “p:2” to the machine device's IPv6 address. As the actual values of the names of the machine device (for example, the machine device's public key and the machine device's IPv6 address) may be previously known to the network node, the pointer values may be used in place of these names in data transmissions to the network node, without any extra signaling of the actual value of the name to the network node.

For example, the pointer values may be pre-arranged by the machine device and the network node. For example, the machine device may indicate to the network node that the first pointer value is associated with a first information type of the first name of the machine device. For example, where the first name comprises an IP address value, the first information type may comprise an IP address, and machine device may transmit an indication that the pointer value, “p:2” for example, is associated with an IP address. The actual string representing the IP address of the machine device does not need to be sent, as the network node may already have access to it. This reduces the amount of data that needs to be transmitted by the machine device to the network node.

The first information type may therefore be the type of data that the first name of the machine device is, for example, an encryption certificate, a public key or an IP address.

In some examples, the machine device may be configured to use a plurality of different names, for example a first name and a second name. For example, the first name may comprise an IP address value of the machine device, and the second name may comprise a public key value of the machine device. The machine device may, in this example, also indicate to the network node that a second pointer value, for example “p:1”, is associated with a second information type, for example a public key.

In some examples, the pointer values and their associated information types may be stored at a registry node.

FIG. 4 illustrates an example method performed by a registry node according to some embodiments.

In step 401, the registry node receives an indication from the machine device that a first pointer value is associated with a first information type of a first name of the machine device.

In step 402, the registry node stores the first pointer value associated with the first information type.

In step 403, the registry node, responsive to receiving an indication of the first pointer value from the network node, transmits the first information type to the network node.

For example, in step 302 of FIG. 3 above, when the network node receives data from the machine device comprising a pointer value, the network node may determine the first name of the machine device by transmitting an indication of the first pointer to a registry node, in order to retrieve the information type that the first pointer value is associated with.

If for example, the network node then receives from the registry node that the first information type is an IP address, the network node may insert the IP address of the machine device into the data.

Using the proposed technique saves bandwidth and energy on the Low Power Wide Area (LPWA) access network and reduces transmission delays. The technique is also simple to implement even in constrained nodes.

Reducing the size of the name field, for example in SenML, may be important as this field may contribute very significantly to the size of data document to be transmitted.

For example, the following is an example of a SenML document to be transmitted by a machine device that uses a public key as its base name. In this example, the machine device comprises a temperature sensor, and is reporting two temperature measurements.

The below illustrates the two reporting measurements if the base name is not replaced by a pointer value. In this example, the public key has been base64 encoded and then transformed (+ signs have been replaced with _ signs) to comply with SenML encoding rules:

[

{“bn”:“AAAAB3NzaC1kc3MAAACBAPY8ZOHY2yFSJA6XYC9HRwNHxaehvx5wO

J0rzZdzoSOXxbETW6ToHv8D1UJ/z_zHo9Fiko5XybZnDlaBDHtblQ_Yp7StxyItHnXF1Y
LfKD1G4T6JYrdHYI14Om1eg9e4NnCRIeaqoZPF3UGfZia6bXrGTQf3gJq2e7Yisk/gF_1
VAAAAFQDb8D5cvwHWTZDPfX0D2s9Rd7NBvQAAAIEAIN92_Bb7D4KLYk3lwRbXblw
XdkPggA4pfdtW9vGfJ0/RHd_NjB4eo1D_0dix6tXwYGN7PKS5R/FXPNwxHPapcj9uL1J
n2AWQ2dsknf_i/FAAvioUPkmdMc0zuWoSOEsSNhVDtX3WdvVcGcBq9cetzrtOKWOoc
JmJ80qadxTRHtUAAACBAN7CY_KKv1gHpRzFwdQm7HK9bb1LAo2KwaoXnadFgeptN
BQeSXG1vO_JsvphVMBJc9HSn24VYtYtsMu74qXviYjziVucWKjjKEb11juqnF0GDIB3V
VmxHLmxnAz643WK42Z7dLM5sY29ouezv4Xz2PuMch5VGPP_CDqzCM4IoWgV”,
“bu”:“Cel”,“bt”:1.276020076e+09, “v”:23.5},

{“v”:24.0, “t”:−1}
]

The receiving network node would understand from this data that the machine device having the public key:

AAAAB3NzaC1kc3MAAACBAPY8ZOHY2yFSJA6XYC9HRwNHxaehvx5wOJ0rzZdzoS
OXxbETW6ToHv8D1UJ/z_zHo9Fiko5XybZnDlaBDHtblQ_Yp7StxyItHnXF1YLfKD1G4T
6JYrdHYI14Om1eg9e4NnCRIeaqoZPF3UGfZia6bXrGTQf3gJq2e7Yisk/gF_1VAAAAFQ
Db8D5cvwHWTZDPfX0D2s9Rd7NBvQAAAIEAIN92_Bb7D4KLYk3lwRbXblwXdkPggA4
pfdtW9vGfJ0/RHd_NjB4eo1D_0dix6tXwYGN7PKS5R/FXPNwxHPapcj9uL1Jn2AWQ2ds
knf_i/FAAvioUPkmdMc0zuWoSOEsSNhVDtX3WdvVcGcBq9cetzrtOKWOocJmJ80qadx
TRHtUAAACBAN7CY_KKv1gHpRzFwdQm7HK9bb1LAo2KwaoXnadFgeptNBQeSXG1
vO_JsvphVMBJc9HSn24VYtYtsMu74qXviYjziVucWKjjKEb11juqnF0GDIB3VVmxHLmxn
Az643WK42Z7dLM5sY29ouezv4Xz2PuMch5VGPP_CDqzCM4loWgV,

has made two measurements, in units of Celsius. The first at a base time 1.276020076e+09 having a value of 23.5° C., and the second at time −1 relative to the base time of 24.0° C.

The same data would be represented as follows if the base name is replaced by a pointer value as described in the Figures above:

[

{“bn”:“p:1”,“bu”:“Cel”,“bt”:1.276020076e+09,“v”:23.5},
{“v”:24.0, “t”:−1},

]

From this data, the network node would understand, either from previous indication from the machine device, or by retrieving the information type from a registry node, that the pointer value p1 relates to the public key of the machine device. The network node may then retrieve the public key of the machine device previously available to the network node, for example, from connection of the machine device to the network node.

The network node would then determine which machine device had made the two measurements, similarly to as above.

As can be observed from the above example, the proposed replacement technique can achieve significant bandwidth savings as the pointer value may comprise vastly less information that the original base name. Instead of a full certificate, also a fingerprint of the certificate can be used to save bytes in the original solution, but still the base name may easily require more bandwidth than all the other information in the document put together.

The structural elements in the SenML document may in some examples, be further compressed with CBOR or EXI [1], but these methods don't compress the contents of the field values; therefore with CBOR/EXI the savings from the proposed method become even more significant.

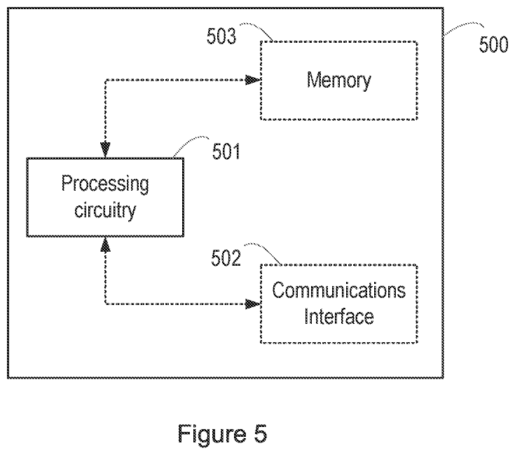

FIG. 5 illustrates an example of a network node 500 according to some embodiments comprising processing circuitry (or logic) 501. For example, the network node may comprise a server or a network gateway as described above. The processing circuitry 501 controls the operation of the network node 500 and can implement the method described herein in relation to a network node 500. The processing circuitry 501 can comprise one or more processors, processing units, multi-core processors or modules that are configured or programmed to control the network node 500 in the manner described herein. In particular implementations, the processing circuitry 501 can comprise a plurality of software and/or hardware modules that are each configured to perform, or are for performing, individual or multiple steps of the method described herein in relation to the network node 500.

Briefly, the processing circuitry 501 of the network node 500 is configured to: receive data from a machine device, and determine a first name of the machine device based on a pointer value in a name field of the data, wherein the first name comprises an identification of the machine device established on connection of the machine device to the network node.

In some embodiments, the network node 500 may optionally comprise a communications interface 502. The communications interface 502 of the network node 500 can be for use in communicating with other nodes, such as other virtual nodes. For example, the communications interface 502 of the network node 500 can be configured to transmit to and/or receive from other nodes requests, resources, information, data, signals, or similar. The processing circuitry 501 of the network node 500 may be configured to control the communications interface 502 of the network node 500 to transmit to and/or receive from other nodes requests, resources, information, data, signals, or similar.

Optionally, the network node 500 may comprise a memory 503. In some embodiments, the memory 503 of the network node 500 can be configured to store program code that can be executed by the processing circuitry 501 of the network node 500 to perform the method described herein in relation to the network node 500. Alternatively or in addition, the memory 503 of the network node 500, can be configured to store any requests, resources, information, data, signals, or similar that are described herein. The processing circuitry 501 of the network node 500 may be configured to control the memory 503 of the network node 500 to store any requests, resources, information, data, signals, or similar that are described herein.

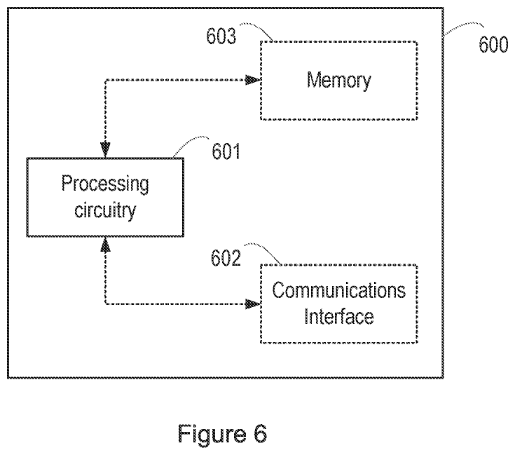

FIG. 6 illustrates an example of a machine device 600 according to some embodiments comprising processing circuitry (or logic) 601. For example, the machine device 600 may comprise a sensor device or an actuator device as described above. The processing circuitry 601 controls the operation of the machine device 600 and can implement the method described herein in relation to a machine device 600. The processing circuitry 601 can comprise one or more processors, processing units, multi-core processors or modules that are configured or programmed to control the machine device 600 in the manner described herein. In particular implementations, the processing circuitry 601 can comprise a plurality of software and/or hardware modules that are each configured to perform, or are for performing, individual or multiple steps of the method described herein in relation to the machine device 600.

Briefly, the processing circuitry 601 of the machine device 600 is configured to: populate a name field in data to be transmitted to the network node with a first pointer value associated with a first name for the machine device, and transmit the data to the network node, wherein the first name comprises an identification of the machine device established on connection of the machine device to the network node.

In some embodiments, the machine device 600 may optionally comprise a communications interface 602. The communications interface 602 of the machine device 600 can be for use in communicating with other nodes, such as other virtual nodes. For example, the communications interface 602 of the machine device 600 can be configured to transmit to and/or receive from other nodes requests, resources, information, data, signals, or similar. The processing circuitry 601 of the machine device 600 may be configured to control the communications interface 602 of the machine device 600 to transmit to and/or receive from other nodes requests, resources, information, data, signals, or similar.

Optionally, the machine device 600 may comprise a memory 603. In some embodiments, the memory 603 of the machine device 600 can be configured to store program code that can be executed by the processing circuitry 601 of the machine device 600 to perform the method described herein in relation to the machine device 600. Alternatively or in addition, the memory 603 of the machine device 600, can be configured to store any requests, resources, information, data, signals, or similar that are described herein. The processing circuitry 601 of the machine device 600 may be configured to control the memory 603 of the machine device 600 to store any requests, resources, information, data, signals, or similar that are described herein.

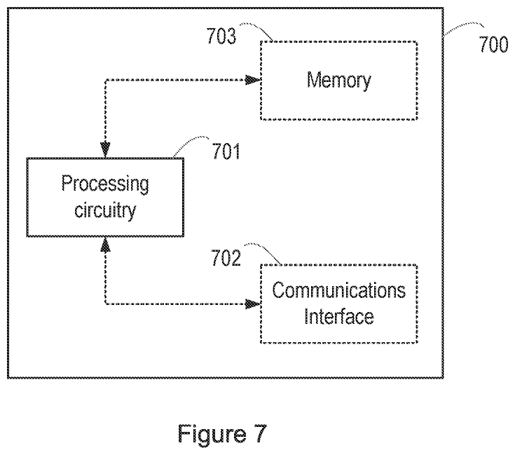

FIG. 7 illustrates an example of a registry node 700 according to some embodiments comprising processing circuitry (or logic) 701. The processing circuitry 701 controls the operation of the registry node 700 and can implement the method described herein in relation to a registry node 700. The processing circuitry 701 can comprise one or more processors, processing units, multi-core processors or modules that are configured or programmed to control the registry node 700 in the manner described herein. In particular implementations, the processing circuitry 701 can comprise a plurality of software and/or hardware modules that are each configured to perform, or are for performing, individual or multiple steps of the method described herein in relation to the registry node 700.

Briefly, the processing circuitry 701 of the registry node 700 is configured to: receive an indication from the machine device that a first pointer value is associated with a first information type of a first name of the machine device, store the first pointer value associated with the first information type, and responsive to receiving an indication of the first pointer value from the network node, transmit the first information type to the network node.

In some embodiments, the registry node 700 may optionally comprise a communications interface 702. The communications interface 702 of the registry node 700 can be for use in communicating with other nodes, such as other virtual nodes. For example, the communications interface 702 of the registry node 700 can be configured to transmit to and/or receive from other nodes requests, resources, information, data, signals, or similar. The processing circuitry 701 of the registry node 700 may be configured to control the communications interface 702 of the registry node 700 to transmit to and/or receive from other nodes requests, resources, information, data, signals, or similar.

Optionally, the registry node 700 may comprise a memory 703. In some embodiments, the memory 703 of the registry node 700 can be configured to store program code that can be executed by the processing circuitry 701 of the registry node 700 to perform the method described herein in relation to the registry node 700. Alternatively or in addition, the memory 703 of the registry node 700, can be configured to store any requests, resources, information, data, signals, or similar that are described herein. The processing circuitry 701 of the registry node 700 may be configured to control the memory 703 of the registry node 700 to store any requests, resources, information, data, signals, or similar that are described herein.

There is therefore provided methods and apparatus for transmitting data from a machine device to a network node such as a network gateway or a server. In particular, a pointer value is used to replace an identification of the machine device in the data.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method in a machine device for transmitting data to a network node, the method comprising:
populating a name field in data to be transmitted to the network node with a first pointer value associated with a first name for the machine device, and
transmitting the data to the network node, wherein the first name comprises an identification of the machine device established on connection of the machine device to the network node.

2. The method as claimed in claim 1 wherein the first name comprises one of: an encryption certificate for the machine device, an IP address of the machine device, or a fingerprint of an encryption certificate for the machine device.

3. The method as claimed in claim 1, further comprising:
indicating to the network node that the first pointer value is associated with a first information type of the first name of the machine device.

4. The method as claimed in in claim 1, further comprising:
indicating to the network node that a second pointer value is associated with a second information type of a second name for the machine device.

5. The method as claimed in claim 3 wherein the first information type is an encryption certificate or an IP address.

6. The method as claimed in claim 1 wherein the network node comprises one of: a server or a network gateway.

7. The method as claimed in claim 1 wherein the machine device comprises one of: a sensor device or an actuator device.

8. A machine device for transmitting data to a server, the machine device comprising processing circuitry configured to:
populate a name field in data to be transmitted to the network node with a first pointer value associated with a first name for the machine device, and
transmit the data to the network node, wherein the first name comprises an identification of the machine device established on connection of the machine device to the network node.

9.-12. (canceled)

13. A method, in a network node, for receiving data from a machine device, the method comprising:
receiving data from the machine device, and
determining a first name of the machine device based on a pointer value in a name field of the data, wherein the first name comprises an identification of the machine device established on connection of the machine device to the network node.

14. The method as claimed in claim 13 wherein the first name comprises one of: an encryption certificate for the machine device, an IP address of the machine device, or a fingerprint of an encryption certificate for the machine device.

15. The method as claimed in claim 13 further comprising:
receiving an indication from the machine device that the first pointer value is associated with a first information type of the first name of the machine device.

16. The method as claimed in claim 13 further comprising:
receiving an indication from the sensor device that a second pointer value is associated with a second information type of a second name for the machine device.

17. The method as claimed in claim 13 further comprising:
transmitting the first pointer value to a registry node,
receiving a first information type of the first name from the registry node.

18. The method as claimed in claim 15 wherein the first information type is an encryption certificate or an IP address.

19.-20. (canceled)

21. A network node, for receiving data from a machine device, the network node comprising processing circuitry configured to:
receive data from the machine device, and
determine a first name of the machine device based on a pointer value in a name field of the data, wherein the first name comprises an identification of the machine device established on connection of the machine device to the network node.

22. The network node as claimed in claim 21 wherein the first name comprises one of: an encryption certificate for the machine device, an IP address of the machine device, or a fingerprint of an encryption certificate for the machine device.

23. The network node as claimed in claim 21 wherein the processing circuitry is further configured to:
receive an indication from the machine device that the first pointer value is associated with a first information type of the first name of the machine device.

24. The network node as claimed in claim 21 wherein the processing circuitry is further configured to:
receive an indication from the machine device that a second pointer value is associated with a second information type of a second name for the machine device.

25. The network node as claimed in claim 21 wherein the processing circuitry is further configured to:
transmit the first pointer value to a registry node; and
receive a first information type of the first name from the registry node.

26. The network node as claimed in claim 23 wherein the first information type is an encryption certificate or an IP address.

27.-30. (canceled)
